(19) United States
(12) Patent Application Publication
(10) Pub. No.: US 2022/0374286 A1
(43) Pub. Date: Nov. 24, 2022

(54) PARALLEL PROCESSING ARCHITECTURE FOR ATOMIC OPERATIONS

(71) Applicant: Ascenium, Inc., Campbell, CA (US)

(72) Inventor: Peter Foley, Los Altos Hills, CA (US)

(73) Assignee: Ascenium, Inc., Campbell, CA (US)

(21) Appl. No.: 17/879,827

(22) Filed: Aug. 3, 2022

Related U.S. Application Data
(63) Continuation-in-part of application No. 17/526,003, filed on Nov. 15, 2021.
Application No. 17/526,003 is a continuation-in-part of application No. 17/465,949, filed on Sep. 3, 2021.
(60) Provisional application No. 63/388,268, filed on Jul. 12, 2022.
(60) Provisional application No. 63/357,030, filed on Jun. 30, 2022.
(60) Provisional application No. 63/340,499, filed on May 11, 2022.
(60) Provisional application No. 63/322,245, filed on Mar. 22, 2022.
(60) Provisional application No. 63/318,413, filed on Mar. 10, 2022.
(60) Provisional application No. 63/295,544, filed on Dec. 31, 2021.
(60) Provisional application No. 63/254,557, filed on Oct. 12, 2021.
(60) Provisional application No. 63/232,230, filed on Aug. 12, 2021.
(60) Provisional application No. 63/229,466, filed on Aug. 4, 2021.
(60) Provisional application No. 63/193,522, filed on May 26, 2021.
(60) Provisional application No. 63/166,298, filed on Mar. 26, 2021.
(60) Provisional application No. 63/125,994, filed on Dec. 16, 2020.
(60) Provisional application No. 63/114,003, filed on Nov. 16, 2020.
(60) Provisional application No. 63/091,947, filed on Oct. 15, 2020.
(60) Provisional application No. 63/075,849, filed on Sep. 9, 2020.
(60) Provisional application No. 63/393,989, filed on Aug. 1, 2022.

(51) Int. Cl. G06F 9/52; G06F 9/48

(52) U.S. Cl. CPC G06F 9/52; G06F 9/4812

(57) ABSTRACT

Techniques for task processing in a parallel processing architecture for atomic operations are disclosed. A two-dimensional array of compute elements is accessed, where each compute element within the array of compute elements is known to a compiler and is coupled to its neighboring compute elements within the array of compute elements. Control for the array of compute elements is provided on a cycle-by-cycle basis. The control is enabled by a stream of wide control words generated by the compiler. At least one of the control words involves an operation requiring at least one additional operation. A bit of the control word is set, where the bit indicates a multicycle operation. The control word is executed, on at least one compute element within the array of compute elements, based on the bit. The multicycle operation comprises a read-modify-write operation.

### RELATED APPLICATIONS

This application claims the benefit of U.S. provisional patent applications “Parallel Processing Architecture For Atomic Operations” Ser. No. 63/229,466, filed Aug. 4, 2021, “Parallel Processing Architecture With Distributed Register Files” Ser. No. 63/232,230, filed Aug. 12, 2021, “Load Latency Amelioration Using Bunch Buffers” Ser. No. 63/254,557, filed Oct. 12, 2021, “Compute Element Processing Using Control Word Templates” Ser. No. 63/295,544, filed Dec. 31, 2021, “Highly Parallel Processing Architecture With Out-Of-Order Resolution” Ser. No. 63/318,413, filed Mar. 10, 2022, “Autonomous Compute Element Operation Using Buffers” Ser. No. 63/322,245, filed Mar. 22, 2022, “Parallel Processing Of Multiple Loops With Loads And Stores” Ser. No. 63/340,499, filed May 11, 2022, “Parallel Processing Architecture With Split Control Word Caches” Ser. No. 63/357,030, file Jun. 30, 2022, “Parallel Processing Architecture With Countdown Tagging” Ser. No. 63/388,268, filed Jul. 12, 2022, and “Parallel Processing Architecture With Dual Load Buffers” Ser. No. 63/393,989, filed Aug. 1, 2022.

This application is also a continuation-in-part of U.S. patent application “Highly Parallel Processing Architecture With Compiler” Ser. No. 17/526,003, filed Nov. 15, 2021, which claims the benefit of U.S. provisional patent applications “Highly Parallel Processing Architecture With Compiler” Ser. No. 63/114,003, filed Nov. 16, 2020, “Highly Parallel Processing Architecture Using Dual Branch Execution” Ser. No. 63/125,994, filed Dec. 16, 2020, “Parallel Processing Architecture Using Speculative Encoding” Ser. No. 63/166,298, filed Mar. 26, 2021, “Distributed Renaming Within A Statically Scheduled Array” Ser. No. 63/193,522, filed May 26, 2021, “Parallel Processing Architecture For Atomic Operations” Ser. No. 63/229,466, filed Aug. 4, 2021, “Parallel Processing Architecture With Distributed Register Files” Ser. No. 63/232,230, filed Aug. 12, 2021, and “Load Latency Amelioration Using Bunch Buffers” Ser. No. 63/254,557, filed Oct. 12, 2021.

The U.S. patent application “Highly Parallel Processing Architecture With Compiler” Ser. No. 17/526,003, filed Nov. 15, 2021 is a continuation-in-part of U.S. patent application “Highly Parallel Processing Architecture With Shallow Pipeline” Ser. No. 17/465,949, filed Sep. 3, 2021, which claims the benefit of U.S. provisional patent applications “Highly Parallel Processing Architecture With Shallow Pipeline” Ser. No. 63/075,849, filed Sep. 9, 2020, “Parallel Processing Architecture With Background Loads” Ser. No. 63/091,947, filed Oct. 15, 2020, “Highly Parallel Processing Architecture With Compiler” Ser. No. 63/114,003, filed Nov. 16, 2020, “Highly Parallel Processing Architecture Using Dual Branch Execution” Ser. No. 63/125,994, filed Dec. 16, 2020, “Parallel Processing Architecture Using Speculative Encoding” Ser. No. 63/166,298, filed Mar. 26, 2021, “Distributed Renaming Within A Statically Scheduled Array” Ser. No. 63/193,522, filed May 26, 2021, Parallel Processing Architecture For Atomic Operations” Ser. No. 63/229,466, filed Aug. 4, 2021, and “Parallel Processing Architecture With Distributed Register Files” Ser. No. 63/232,230, filed Aug. 12, 2021.

Each of the foregoing applications is hereby incorporated by reference in its entirety.

### FIELD OF ART

This application relates generally to task processing and more particularly to a parallel processing architecture for atomic operations.

### BACKGROUND

Computational resources are designed, specified, purchased, configured, and deployed by organizations engaged in various activities. The organizations range in size from one-person operations engaged in local, niche activities, to large, international organizations whose myriad activities have global reach. The computational resources are designed for the data processing requirements of these organizations and include processors, data storage units, networking and communications equipment, power conditioning units, HVAC equipment, and backup power units, among other essential equipment. Energy resource management is also critical since the computational resources consume substantial amounts of energy. The computational resources can be housed in special-purpose rooms, buildings, or campuses. The installations are typically high security, permitting limited access only to authorized personnel. These special-purpose installations more closely resemble vaults than office buildings. While not every organization requires vast computational equipment installations, all seek to provide the equipment required to meet their data processing needs. The computational resources must meet the requirements of the organizations that use them, quickly and cost effectively.

The primary function of the computational resource installations is the processing data. The types of data that are processed directly derive from the missions of the organizations. The organizations, which include commercial, governmental, medical, educational, research, or retail enterprises, among many others, execute a wide variety of processing jobs. The processing jobs include running billing and payroll, accounting, generating profit and loss statements, processing tax returns or election results, controlling experiments and analyzing research data, and generating academic grades, to name only a few. The need for these processing jobs to be executed quickly, accurately, and cost-effectively is critical. The datasets can be very large, thereby straining the capabilities of the computational resources. Further, the datasets can be unstructured, resulting in the necessity to process an entire dataset to find a particular data element. Effective processing of a dataset can be a boon for an organization, by identifying potential customers, or by fine-tuning production and distribution systems, among other results that yield a competitive advantage. Ineffective data processing wastes money by losing sales or failing to streamline a process, thereby increasing costs.

The organizations collect their data using data collection techniques. The techniques harvest the data from a diverse range of individuals. At times, the individuals are willing participants, while at others they are unwitting subjects of data collection. Common data collection techniques include “opt-in” techniques, where an individual signs up, registers, enrolls, creates an account, or otherwise willingly agrees to participate in the data collection. Other techniques are legislative, such as a government requiring citizens to obtain a registration number and to use that number while interacting with government agencies, law enforcement, emergency services, and others. Additional data collection techniques are more subtle or are even completely hidden, such as tracking purchase histories, website visits, button clicks, and menu choices. Irrespective of the techniques used for the data collection, the collected data is highly valuable to the organizations if processed rapidly and accurately.

### SUMMARY

Organizations execute significant numbers of routine and mission-critical data processing jobs. The jobs that are processed, whether for analyzing research data, running payroll, processing billing, or training a neural network for machine learning, are composed of many complex tasks. The tasks can include accessing, loading, and storing various datasets; accessing processing components and systems; and so on. The tasks themselves are typically based on subtasks, where the subtasks can be used to handle specific jobs such as loading or reading data from storage, performing computations such as linear regression on the data, storing or writing the data back to storage, handling inter-subtask communication such as data transfer and control, and so on. The datasets that are accessed are often very large and can easily saturate processing architectures that are neither suited to the processing tasks nor flexible in their designs. To greatly enhance task processing efficiency and throughput, two-dimensional (2D) arrays of elements can be used effectively for the task and subtask processing. The 2D arrays include compute elements, multiplier elements, caches, queues, controllers, decompressors, arithmetic logic units (ALUs), storage elements, and further components which can communicate among themselves. These arrays of elements are configured and operated by providing fine-grained control to the array on a cycle-by-cycle basis. The control of the 2D array is accomplished by providing control words generated by a compiler. Control is based on a stream of control words, where the control words can include wide, variable length, microcode control words that are generated by a compiler. The control words are used to configure the array and to control the processing of data by the tasks and subtasks. Further, the arrays can be dynamically configured in a physical interconnection topology which is best suited to the processing of various types of tasks. The topologies into which the arrays can be configured include a systolic, a vector, a cyclic, a spatial, a streaming, or a Very Long Instruction Word (VLIW) topology, among others. The topologies can include a topology that enables machine learning functionality.

Task processing is based on a parallel processing architecture that supports multicycle atomic operations. A processor-implemented method for task processing is disclosed comprising: accessing a two-dimensional (2D) array of compute elements, wherein each compute element within the array of compute elements is known to a compiler and is coupled to its neighboring compute elements within the array of compute elements; providing control for the array of compute elements on a cycle-by-cycle basis, wherein the control is enabled by a stream of wide control words generated by the compiler, and wherein at least one of the control words involves an operation requiring at least one additional operation; setting a bit of the at least one control word, wherein the bit indicates a multicycle operation; and executing the at least one control word, on at least one compute element within the array of compute elements, based on the bit. The multicycle operation can include a read-modify-write (RMW) operation. The bit of the at least one control word can be used as a lock, an inhibitor, and so on. The bit can inhibit the at least one compute element from having its operation interrupted. The interrupted operation can include an attempted thread swap out.

Embodiments include setting one or more additional bits on one or more control words immediately following (i.e., contiguously) the at least one control word. The control words immediately following the at least one control word can provide further operations associated with the control word, such as data fetching and storage, logical operations, mathematical operations, and so on. The one or more additional bits can continue to inhibit the at least one compute element from having its operation interrupted. The bit and the one or more additional bits can effectively form a lock that can block interrupts, exceptions, and so on. The bit can be used to enable selective interrupt handling or enablement. A non-maskable interrupt (NMI) can override the setting of the lock bit. Examples of a non-maskable interrupt can include an arithmetic exception such as overflow or underflow, or a memory exception such as a read or write timeout, that can override the setting of the lock bit. In embodiments, the compiler can map machine learning functionality to the array of compute elements. The mapping can include configuring compute elements, storage elements, communications elements, and so on. In embodiments, the machine learning functionality can include a network implementation such as a neural network implementation.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for a parallel processing architecture for atomic operations.

FIG. 2 is a flow diagram for additional bit setting.

FIG. 3 shows a system block diagram for a highly parallel architecture with a shallow pipeline.

FIG. 4 illustrates compute element array detail.

FIG. 5 is a block diagram for atomic operation.

FIG. 6 shows a system block diagram for compiler interactions.

FIG. 7 is a system diagram for a parallel processing architecture for atomic operations.

### DETAILED DESCRIPTION

Techniques for task processing based on a parallel processing architecture for atomic operations are disclosed. The tasks that are executed can be associated with a wide range of applications based on data manipulation, such as image or audio processing, AI, business, research, modeling and simulation, and so on. The tasks, where the tasks themselves can be based on subtasks, can include a variety of data operations. The operations can include arithmetic operations and manipulations, shift operations, logical operations including Boolean operations, vector or matrix operations, tensor operations, and the like. The subtasks can be executed based on precedence, priority, ranking, coding order, amount of parallelization, data flow, data availability, compute element availability, communication channel availability, the data itself, etc. The data manipulations are performed on a two-dimensional (2D) array of compute elements. The compute elements within the 2D array can be implemented with central processing units (CPUs), graphics processing units (GPUs), application specific integrated circuits (ASICs), field programmable gate arrays (FPGAs), processing cores, or other processing components or combinations of processing components. The compute elements can include heterogeneous processors, homogeneous processors, processor cores within an integrated circuit or chip, etc. The compute elements can be coupled to local storage, where the local storage can include local memory elements, register files, cache storage, etc. The cache, which can include a hierarchical cache, such as L1, L2, and L3 cache, can be used for storing data such as intermediate results, compressed control words, coalesced control words, decompressed control words, relevant portions of a control word, and the like. The cache can store data produced by a taken branch path, where the taken branch path is determined by a branch decision. The decompressed control word is used to control one or more compute elements within the array of compute elements. Multiple layers of the two-dimensional (2D) array of compute elements can be “stacked” to comprise a three-dimensional (3D) array of compute elements. Similar to the compute elements within the 2D array if compute elements, each compute element within the 3D array of compute elements is known to a compiler and is coupled to its neighboring compute elements within the array of compute elements.

The tasks, subtasks, etc., that are associated with the data processing operations are generated by a complier. The compiler can include a general-purpose compiler, a hardware description-based compiler, a compiler written or “tuned” for the array of compute elements, a constraint-based compiler, a satisfiability-based compiler (SAT solver), and so on. Control is provided to the hardware in the form of control words, where the control words are provided on a cycle-by-cycle basis. The one or more control words are generated by the compiler. The control words can include wide, variable length, microcode control words. The length of a microcode control word can be adjusted by compressing the control word, by recognizing when a compute element is unneeded by a task so that control bits within the control word are not required for that compute element, etc. The control words can be used to route data, to set up operations to be performed by the compute elements, to idle individual compute elements or rows and/or columns of compute elements, etc. The compiled microcode control words associated with the compute elements are distributed to the compute elements. The compute elements are controlled by a control unit which operates on decompressed control words. The control words enable processing by the compute elements. The task processing is enabled by executing the one or more control words.

In order to accelerate the execution of tasks, to reduce or eliminate stalling of the array of compute elements, and so on, the task processing can include atomic operations. An atomic operation can include an operation which can execute independently of other operations. Atomic operations can enable parallel execution of tasks and subtasks, linearization of tasks and subtasks, etc. An atomic operation can include accessing data, processing data, storing data, and so on. In the context of a parallel processing architecture, an atomic operation can be based on one or more temporally sequential control words, where the control words can enable a multicycle operation. Thus, an atomic operation can include multi-cycle, contiguous operations marked by a lock bit that cannot be interrupted by certain events such as a task or thread switch that otherwise would change the control flow, i.e., the sequence of control words. Note that the specification of which events are or are not blocked by the lock bit is definable by the compiler. In embodiments, the multicycle operation comprises a read-modify-write (RMW) operation. In order to enable an atomic operation based on one or more control words, a bit associated with a control word can be set. As the control word is used to control execution of a task or subtask by a compute element, the bit can be used to indicate that the operation with which the bit is associated may not be interrupted. Bits associated with the one or more further control words can also be set. The bit or bits that can be set essentially form control word atomic lock bits. In embodiments, the bit inhibits the at least one compute element from having its operation interrupted. The “inhibition” of interruptions can continue for each subsequent control word for which the associated bit is set. When a control word is encountered, for which the associated bit is not set, then the inhibition can be removed. There are instances for which even an atomic operation based on one or more control words can be interrupted. In embodiments, a non-maskable interrupt (NMI) overrides the setting of a lock bit. An exception can include an arithmetic exception such as an overflow, an underflow, division by zero, and so on. An exception can also include a memory exception such as: needed data is unavailable, a memory access timeout, etc. An exception can further include task switches or other events.

A parallel processing architecture for atomic operations enables task processing. A two-dimensional (2D) array of compute elements is accessed. The compute elements can include compute elements, processors, or cores within an integrated circuit; processors or cores within an application specific integrated circuit (ASIC); cores programmed within a programmable device such as a field programmable gate array (FPGA); and so on. The compute elements can include homogeneous or heterogeneous processors. Each compute element within the array of compute elements is known to a compiler. The compiler, which can include a general-purpose compiler, a hardware-oriented compiler, or a compiler specific to the compute elements, can compile code for each of the compute elements. The coupling of the compute elements enables data communication between and among compute elements. Thus, the compiler can control data flow between and among the compute elements, and can also control data commitment to memory outside of the array. The control is provided to the hardware via one or more control words generated by the compiler. The control can be provided on a cycle-by-cycle basis. The cycle can include a clock cycle, a data cycle, a processing cycle, a physical cycle, an architectural cycle, etc. The control is enabled by a stream of wide control words generated by the compiler. The control words can include microcode control words, operation control, an instruction equivalent, a building block for a high-level language, and the like. The lengths of the control words, such as the microcode control word, can vary based on the type of control, compression, simplification such as identifying that a compute element is unneeded, etc. The control words, which can include compressed control words, coalesced control words, etc., can be decoded, expanded, etc., and can further be provided to a control unit which controls the array of compute elements. The control word can be decompressed to a level of fine control granularity, where each compute element (whether an integer compute element, floating point compute element, address generation compute element, write buffer element, read buffer element, etc.), is individually and uniquely controlled. A bit of the at least one control word is set, where the bit indicates a multicycle operation. The bits associated with subsequent control words can also be set to indicate that the control word and the subsequent control words comprise the multicycle operation. The multicycle operation can comprise a multicycle atomic operation. The at least one control word is executed, on at least one compute element within the array of compute elements, based on the bit. If the control word that is being executed has its associated bit set, then the bit can inhibit the at least one compute element from having its operation interrupted. The execution of the control can be interrupted if a non-maskable interrupt (NMI) occurs. The NMI can include an arithmetic exception, a memory exception, and so on. If the bit associated with the control word is not set, then the execution of the control word can be interrupted.

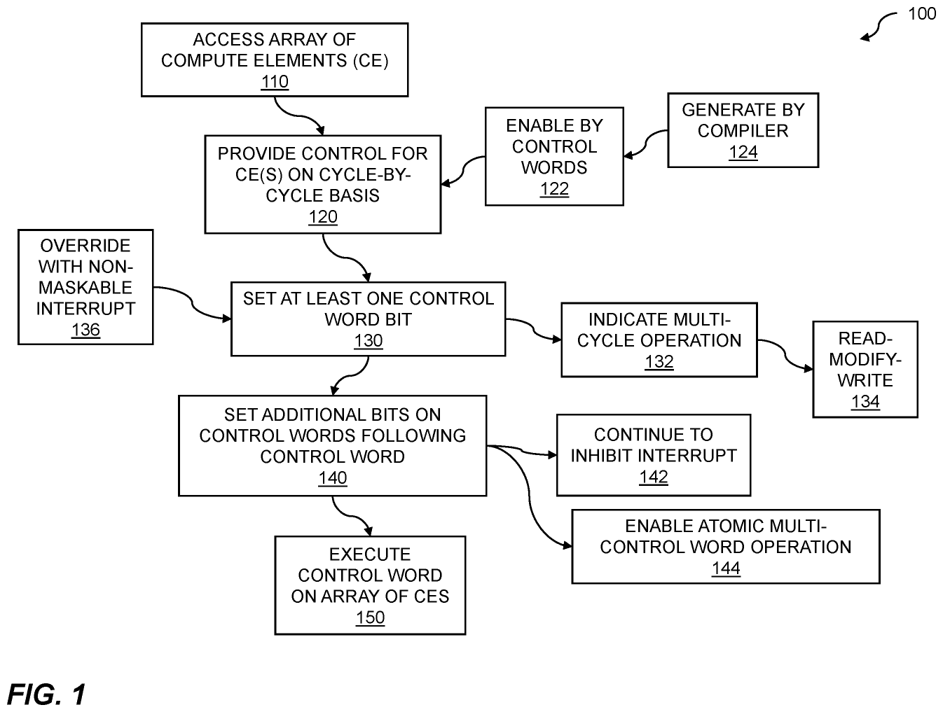

FIG. 1 is a flow diagram for a parallel processing architecture for atomic operations. Groupings of compute elements (CEs), such as CEs assembled within a 2D array of CEs, can be configured to execute a variety of operations associated with task processing. The tasks, which can be associated with program execution, can be based on subtasks associated with the tasks. The 2D array can further interface with other elements, where the elements can include controllers, storage elements, ALUs, multiplier elements, memory management units (MMUs), various levels of cache storage, and so on. The operations can accomplish a variety of processing objectives such as application processing, data manipulation, and so on. The operations can operate on a variety of data types including integer, real, character, and string data types; vectors and matrices; tensors; etc. Control is provided to the array of compute elements on a cycle-by-cycle basis, where the control is based on control words generated by a compiler. The control words, which can include microcode control words, enable or idle various compute elements; provide data; route results between or among CEs, caches, and storage; and the like. The control enables compute element operation, memory access precedence, etc. Compute element operation and memory access precedence enable the hardware to properly sequence compute element results. The control enables execution of tasks, subtasks, and so on, associated with a compiled program, on the array of compute elements. Further, more than one control word can be associated with an atomic operation, where an atomic operation can execute independently of other operations performed by the compute elements. A multicycle operation based on the one or more control words can be indicated by setting a bit associated with each of the control words. Multiple control words can comprise a multicycle operation, such as a read-modify-write (RMW) operation. The set bit associated with a control word inhibits the at least one compute element from having its operation interrupted while the operation is executed. A non-maskable interrupt (NMI), such as an arithmetic exception of a memory exception, can override the setting a bit.

The flow 100 includes accessing a two-dimensional (2D) array 110 of compute elements, wherein each compute element within the array of compute elements is known to a compiler and is coupled to its neighboring compute elements within the array of compute elements. The compute elements can be based on a variety of types of processors. The compute elements or CEs can include central processing units (CPUs), graphics processing units (GPUs), processors or processing cores within application specific integrated circuits (ASICs), processing cores programmed within field programmable gate arrays (FPGAs), and so on. In embodiments, compute elements within the array of compute elements have identical functionality. The compute elements can include heterogeneous compute resources, where the heterogeneous compute resources may or may not be collocated within a single integrated circuit or chip. The compute elements can be configured in a topology, where the topology can be built into the array, programmed or configured within the array, etc. In embodiments, the array of compute elements is configured by the control word to implement one or more of a systolic, a vector, a cyclic, a spatial, a streaming, or a Very Long Instruction Word (VLIW) topology. In other embodiments, the stream of wide control words generated by the compiler can provide direct, fine-grained control of the 2D array of compute elements. In yet other embodiments, the stream of wide control words generated by the compiler comprise variable length control words.

The compute elements can be coupled to other elements within the array of CEs. In embodiments, the coupling of the compute elements can enable one or more topologies. The other elements to which the CEs can be coupled can include storage elements such as one or more levels of cache storage; multiplier units; address generator units for generating load (LD) and store (ST) addresses; queues; and so on. The compiler to which each compute element is known can include a C, C++, or Python compiler. The compiler to which each compute element is known can include a compiler written especially for the array of compute elements. The coupling of each CE to its neighboring CEs enables sharing of elements such as cache elements, multiplier elements, ALU elements, or control elements; communication between or among neighboring CEs; and the like. The compute elements can further include a topology suited to machine learning computation. The topology for machine learning computation can be configured by the compiler. In embodiments, the compiler can map machine learning functionality to the array of compute elements. The machine learning functionality can be based on techniques such as regression, classification, clustering, and so on. In embodiments, the machine learning functionality can include a neural network implementation. The neural network implementation can be based on a network comprising one or more of input layers, hidden layers, output layers, bottleneck layers, and so on.

The flow 100 includes providing control 120 for the array of compute elements on a cycle-by-cycle basis. The control for the array can include configuration of elements such as compute elements within the array, loading and storing data; routing data to, from, and among compute elements; and so on. In the flow 100, the control is enabled 122 by a stream of wide control words, where at least one of the control words involves an operation requiring at least one additional operation. The control words can configure the compute elements and other elements within the array; enable or disable individual compute elements, rows and/or columns of compute elements; load and store data; route data to, from, and among compute elements; and so on. In embodiments, the stream of wide control words generated by the compiler provides direct, fine-grained control of the 2D array of compute elements. The fine-grained control can include a column of compute elements within the array, a row of compute elements, individual compute elements, clusters of compute elements, and the like. In embodiments, the operation can include an atomic operation. An atomic operation can be performed independently of other operations. An atomic operation can consume data, process or manipulate date, generate data, and so on. Control words associated with an operation that requires at least one additional operation can be thought of as an atomic operation that spans multiple control words. The atomic operation that spans the multiple control words can perform more than one operation, where the operations can include data access, data processing, and so on. The operation can include a multicycle operation (discussed below). In embodiments, the multicycle operation can include a read-modify-write (RMW) operation.

The one or more control words are generated 124 by the compiler. The compiler which generates the control words can include a general-purpose compiler such as a C, C++, or Python compiler; a hardware description language compiler such as a VHDL or Verilog compiler; a compiler written for the array of compute elements; and the like. The compiler can be used to map functionality to the array of compute elements. In embodiments, the compiler can map machine learning functionality to the array of compute elements. The machine learning can be based on a machine learning (ML) network, a deep learning (DL) network, a support vector machine (SVM), etc. In embodiments, the machine learning functionality can include a neural network (NN) implementation. A control word generated by the compiler can be used to configure one or more CEs, to enable data to flow to or from the CE, to configure the CE to perform an operation, and so on. Depending on the type and size of a task that is compiled to control the array of compute elements, one or more of the CEs can be controlled, while other CEs are unneeded by the particular task. A CE that is unneeded can be marked in the control word as unneeded. An unneeded CE requires no data, nor is a control word required by it. In embodiments, the unneeded compute element can be controlled by a single bit. In other embodiments, a single bit can control an entire row of CEs by instructing hardware to generate idle signals for each CE in the row. The single bit can be set for “unneeded”, reset for “needed”, or set for a similar usage of the bit to indicate when a particular CE is unneeded by a task.

The control words that are generated by the compiler can include control words that require at least one additional control word. Discussed throughout, the control word and the at least one additional control word can be associated with an advanced or complex atomic operation. The atomic operation can combine two or more operations. The code that is generated by the compiler can include code associated with an application such as image processing, audio processing, and so on. The code can include data access operations, processing operations, etc. The code can include conditions which can cause execution of a sequence of code to transfer to a different sequence of code. The code words can include compressed code words. The control words can be a decompressed by a decompressor logic block that decompresses words from a compressed control word cache on their way to the array. In embodiments, the set of directions can include a spatial allocation of subtasks on one or more compute elements within the array of compute elements. In other embodiments, the set of directions can enable multiple programming loop instances circulating within the array of compute elements. The multiple programming loop instances can include multiple instances of the same programming loop, multiple programming loops, etc.

Relevant portions of the control word can be stored within a cache, register file, or other storage associated with the array of compute elements. The control word stored in the cache can include a compressed control word, a decompressed control word, and so on. In embodiments, an access queue can be associated with the cache, where the access queues can be used to queue requests to access caches, storage, and so on, for storing data and loading data. The data cache can include a multilevel cache such as a level 1 (L1) cache, a level 2 (L2) cache, and so on. The L1 caches can be used to store blocks of data to be processed. The L1 cache can include a small, fast memory that is quickly accessible by the compute elements and other components. The L2 caches can include larger, slower storage in comparison to the L1 caches. The L2 caches can store “next up” data, results such as intermediate results, and so on. In embodiments, the L1 and L2 caches can further be coupled to a level 3 (L3) cache. The L3 caches can be larger than the L2 and L1 caches and can include slower storage. Accessing data from the L3 caches is still faster than accessing off-chip main storage. In embodiments, the L1, L2, and L3 caches can include 4-way set associative caches. In embodiments, the cache can include a dual read, single write (2R1 W) data cache. As the name implies, a 2R1 W data cache can support up to two read operations and one write operation simultaneously without causing read/write conflicts, race conditions, data corruption, and the like. In embodiments, the 2R1 W cache can support simultaneous fetch of potential branch paths for the compiler. Recall that a branch condition can control two or more branch paths, that is, both the branch path taken and the other branch paths not taken are determined by a branch decision.

The flow 100 includes setting a bit 130 of the at least one control word. The bit can include a bit within the control word, a bit associated with the control word, and so on. The bit can comprise a lock bit. In embodiments, the bit can include a control word atomic lock bit. The value to which the bit can be set can include a zero or a one. In embodiments, the bit can inhibit the at least one compute element from having its operation interrupted. An interrupt can occur based on a task priority or precedence, on a control signal, and so on. Inhibiting an interrupt can enable the atomic operation to complete successfully. In embodiments, the interrupted operation can include an attempted thread swap out. The attempted thread swap out can be delayed until completion of the operation that initiated the inhibiting. Embodiments further include enabling selective interrupt enablement based on the setting a bit. The selective interrupt enablement can enable some or all interrupts, can prioritize interrupts, can assign precedence to interrupts, and so on. In embodiments, the selective interrupt enablement can further be based on setting an additional bit. In the flow 100, the setting the bit indicates a multicycle operation 132. The multicycle operation can include one or more operations, where a single operation can span multiple cycles, an operation can be performed during each of the multiple cycles, multiple operations can span multiple cycles, etc. Discussed throughout, a multicycle operation can include two or more atomic operations to form an atomic operation that can perform multiple operations. The atomic operations can include accessing storage, processing or manipulating data, and the like. In the flow 100, the multicycle operation performs a read-modify-write (RMW) operation 134. The read and the write operations can access data in a cache, storage within the array of compute elements, storage coupled to the array of compute elements, and so on. The modify operation can include an arithmetic operation, a logical operation, etc. In embodiments, successful completion of the at least one additional operation comprises an atomic operation. In the flow 100, a non-maskable interrupt (NMI) overrides 136 the setting a bit. The NMI can include a system level interrupt such as an operating system interrupt, an exception such as an operation exception or a data exception, and so on. In embodiments, an arithmetic exception or a memory exception can override the setting a bit.

The flow 100 further includes setting one or more additional bits 140 on one or more control words immediately following the at least one control word. The setting one or more additional bits can include setting the bits to one or zero. The additional bits, which can be set by the compiler, can indicate that a sequence of control words is to be executed as a sequence and without interruption. In the flow 100, setting the one or more additional bits can continue to inhibit 142 the at least one compute element from having its operation interrupted. As for the set bits of the other control words, a non-maskable interrupt, such as an interrupt generated by an arithmetic or memory exception, can override the setting the additional bits. In the flow 100, the bit and the one or more additional bits enable 144 an atomic, multi-control word operation. Discussed below, an atomic duration can be associated with the atomic multi-control word operation. In embodiments, an atomic duration can be controlled by a number of consecutive control words having their multicycle operation bits set. The atomic duration can be used to control processing order, memory access, and so on. In embodiments, the atomic duration enables a memory access barrier. The memory access barrier can be used to block memory access by other tasks, subtasks, and so on, while an operation is completing manipulation or modification of data. The memory access barrier can be used to prevent race conditions.

The flow 100 includes executing the at least one control word 150, on at least one compute element within the array of compute elements, based on the bit. Discussed previously, control words associated with tasks and subtasks can be generated by a compiler. The tasks and subtasks can be associated with applications such as video processing applications, audio procession applications, medical or consumer data processing, and so on. The executing one or more control words can be based on a schedule, a priority, a precedence, and the like. In embodiments, the control words can enable simultaneous execution of two or more control words. The control words can control loading data, modifying or manipulating data, storing data, etc. The control word can be executed based on an architectural cycle, where an architectural cycle can enable an operation across the array of elements such as compute elements. In embodiments, the same control word can be executed on a given cycle across the array of compute elements. The execution of control words can be performed on spatially separate compute elements. Using spatially separate compute elements can better manage array resources, can reduce data contention or control conflicts, and so on.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

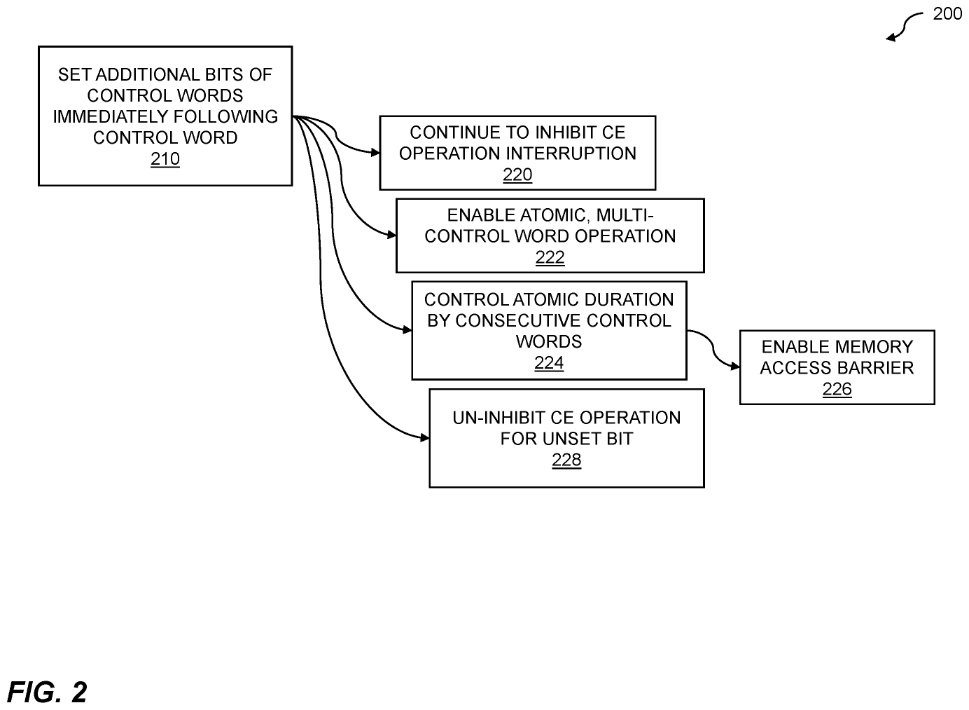

FIG. 2 is a flow diagram for additional bit setting. Discussed above and throughout, various types of tasks, subtasks, and so on, can be executed on one or more elements associated with an array of compute elements. A task can include general operations such as arithmetic, vector, array, or matrix operations; Boolean operations such as NAND, NOR, XOR, or NOT operations; operations based on applications such as neural network or deep learning operations; and so on. In order for the tasks to be processed correctly, control words are provided, on a cycle-by-cycle basis, to the array of compute elements. The control words configure the array to execute tasks. The control words can be provided to the array of compute elements by a compiler. The control words can include an associated bit, where the associated bit can indicate a multicycle operation. The multicycle operation can include an atomic operation. The providing control words that control placement, scheduling, data transfers, and so on, within the array, can maximize task processing throughput. This maximization ensures that a task that generates data required by a second task is processed prior to the processing of the second task, and so on. An atomic operation associated with a task is an operation that can be executed independently of other operations. Two or more atomic operations can enable parallelization of task execution, linearization of execution, and so on. Additional bit setting enables a parallel processing for atomic operations. A two-dimensional (2D) array of compute elements is accessed, wherein each compute element within the array of compute elements is known to a compiler and is coupled to its neighboring compute elements within the array of compute elements. Control for the array of compute elements is provided on a cycle-by-cycle basis, wherein the control is enabled by a stream of wide control words generated by the compiler, and wherein at least one of the control words involves an operation requiring at least one additional operation. A bit of the at least one control word is set, wherein the bit indicates a multicycle operation. The at least one control word is executed, on at least one compute element within the array of compute elements, based on the bit.

The flow 200 includes setting one or more additional bits 210 of one or more control words immediately following the at least one control word. The one or more control words immediately following the at least one control word can comprise control words associated with an atomic operation. In embodiments, the operation requiring at least one additional operation can be indicated in the at least one of the control words and a subsequent control word. In the flow 200, the one or more additional bits continue to inhibit 220 the at least one compute element from having its operation interrupted. The operation interruption can be generated by another task or thread, a branch of a directed graph, and so on. In embodiments, the interrupted operation can include an attempted thread swap out. The attempted thread swap out can thereby be delayed until completion of one or more control words associated with the one or more additional bits. In the flow 200, the bit and the one or more additional bits can enable 222 an atomic, multi-control word operation. The multi-control word operation can perform more complex atomic operations by executing a sequence of atomic operations. The atomic operations can include data access, data manipulation, data transfer, and so on. In embodiments, the atomic multi-control word operation can include a read-modify-write (RMW) operation. The “modify” portion of the RMW operation can include an arithmetic operation, a logical operation, etc.

A duration can be associated with the multi-control word operation, where the duration can be based on the number of control words associated with the operation. In the flow 200, an atomic duration 224 can be controlled by a number of consecutive control words having their lock bits set. The atomic duration can include one control word, two or more control words, and so on. The atomic duration can be used to block access to processors, communications channels, storage, etc. by the atomic operation until the atomic operation has been completed. In the flow 200, the atomic duration can enable a memory access barrier 226. The access barrier can persist for the atomic duration and can be removed after the atomic duration. Inhibited access can be removed. The flow 200 further includes un-inhibiting 228 the at least one compute element upon receipt of a control word, without having its multi-cycle operation bit set. The control word with the multi-cycle operation bit set can indicate the end of a sequence of control words associated with a multi-cycle operation, an atomic operation independent of the multi-cycle operation, and so on.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

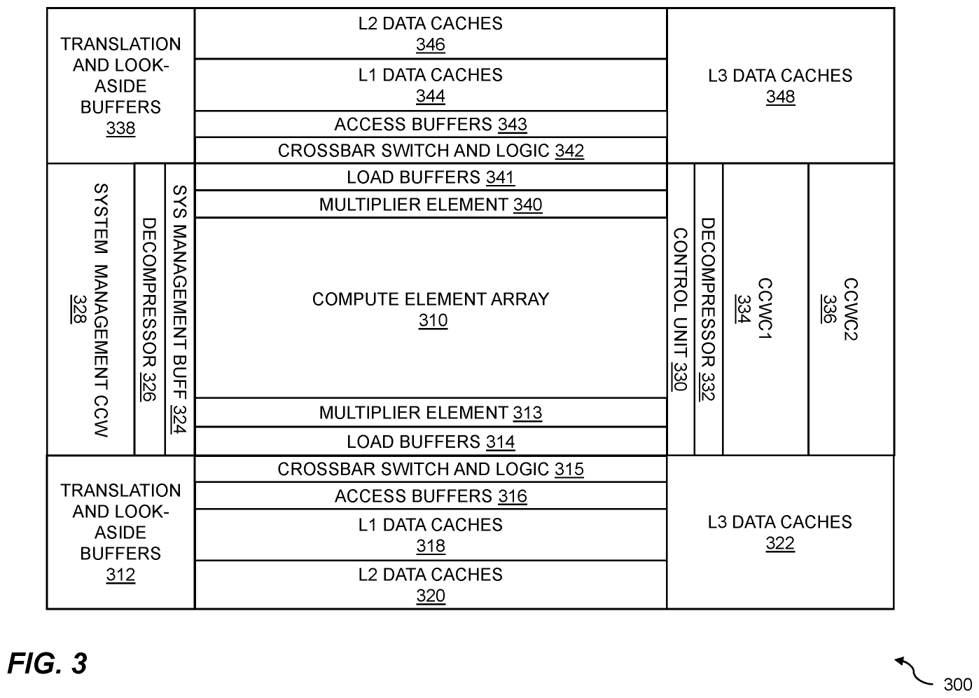

FIG. 3 illustrates a system block diagram for a highly parallel architecture with a shallow pipeline. The highly parallel architecture can comprise components including compute elements, processing elements, buffers, one or more levels of cache storage, system management, arithmetic logic units, multipliers, memory management units, and so on. The various components can be used to accomplish parallel processing of tasks, subtasks, and so on. The task processing is associated with program execution, job processing, application processing, etc. An atomic operation associated with a task is an operation that can be executed independently of other operations. Two or more atomic operations can enable parallelization of task execution, linearization of execution, and so on. Additional bit setting enables a parallel processing for atomic operations. A two-dimensional (2D) array of compute elements is accessed, wherein each compute element within the array of compute elements is known to a compiler and is coupled to its neighboring compute elements within the array of compute elements. Control for the array of compute elements is provided on a cycle-by-cycle basis, wherein the control is enabled by a stream of wide control words generated by the compiler, and wherein at least one of the control words involves an operation requiring at least one additional operation. A bit of the at least one control word is set, wherein the bit indicates a multicycle operation. The at least one control word is executed, on at least one compute element within the array of compute elements, based on the bit.

A system block diagram 300 for a highly parallel architecture with a shallow pipeline is shown. The system block diagram can include a compute element array 310. The compute element array 310 can be based on compute elements, where the compute elements can include processors, central processing units (CPUs), graphics processing units (GPUs), coprocessors, and so on. The compute elements can be based on processing cores configured within chips such as application specific integrated circuits (ASICs), processing cores programmed into programmable chips such as field programmable gate arrays (FPGAs), and so on. The compute elements can comprise a homogeneous array of compute elements. The system block diagram 300 can include translation and look-aside buffers such as translation and look-aside buffers 312 and 338. The translation and look-aside buffers can comprise memory caches, where the memory caches can be used to reduce storage access times.

The system block diagram 300 can include logic for load and store access order and selection. The logic for load and store access order and selection can include crossbar switch and logic 315 along with crossbar switch and logic 342. Switch and logic 315 and can accomplish load and store access order and selection for the lower data cache blocks (318 and 320), and switch and logic 342 can accomplish load and store access order and selection for the upper data cache blocks (344 and 346). Crossbar switch and logic 315 enables high-speed data communication between lower-half compute elements of compute element array 310 and data caches 318 and 320 using access buffers 316. Crossbar switch and logic 342 enables high-speed data communication between upper-half compute elements of compute element array 310 and data caches 344 and 346 using access buffers 343. The access buffers 316 and 343 allow logic 315 and logic 342, respectively, to hold load or store data until any memory hazards are resolved. In addition, splitting the data cache between physically adjacent regions of the compute element array can enable the doubling of load access bandwidth, the reducing of interconnect complexity, and so on. While loads can be split, stores can be driven to both lower data caches 318 and 320 and upper data caches 344 and 346.

The system block diagram 300 can include lower load buffers 314 and upper load buffers 341. The load buffers can provide temporary storage for memory load data so that it is ready for low latency access by the compute element array 310. The system block diagram can include dual level 1 (L1) data caches, such as L1 data caches 318 and 344. The L1 data caches can be used to hold blocks of load and/or store data, such as data to be processed together, data to be processed sequentially, and so on. The L1 cache can include a small, fast memory that is quickly accessible by the compute elements and other components. The system block diagram can include level 2 (L2) data caches. The L2 caches can include L2 caches 320 and 346. The L2 caches can include larger, slower storage in comparison to the L1 caches. The L2 caches can store “next up” data, results such as intermediate results, and so on. The L1 and L2 caches can further be coupled to level 3 (L3) caches. The L3 caches can include L3 caches 322 and 348. The L3 caches can be larger than the L2 and L1 caches and can include slower storage. Accessing data from L3 caches is still faster than accessing main storage. In embodiments, the L1, L2, and L3 caches can include 4-way set associative caches.

The system block diagram 300 can include lower multiplier element 313 and upper multiplier element 340. The multiplier elements can provide an efficient multiplication function of data coming out of the compute element array and/or data moving into the compute element array. Multiplier element 313 can be coupled to the compute element array 310 and load buffers 314, and multiplier element 340 can be coupled to compute element array 310 and load buffers 341.

The system block diagram 300 can include a system management buffer 324. The system management buffer can be used to store system management codes or control words that can be used to control the array 310 of compute elements. The system management buffer can be employed for holding opcodes, codes, routines, functions, etc. which can be used for exception or error handling, management of the parallel architecture for processing tasks, and so on. The system management buffer can be coupled to a decompressor 326. The decompressor can be used to decompress system management compressed control words (CCWs) from system management compressed control word buffer 328 and can store the decompressed system management control words in the system management buffer 324. The compressed system management control words can require less storage than the uncompressed control words. The system management CCW component 328 can also include a spill buffer. The spill buffer can comprise a large static random-access memory (SRAM) which can be used to support multiple nested levels of exceptions.

The compute elements within the array of compute elements can be controlled by a control unit such as control unit 330. While the compiler, through the control word, controls the individual elements, the control unit can pause the array to ensure that new control words are not driven into the array. The control unit can receive a decompressed control word from a decompressor 332 and can drive out the decompressed control word into the appropriate compute elements of compute element array 310. The decompressor can decompress a control word (discussed below) to enable or idle rows or columns of compute elements, to enable or idle individual compute elements, to transmit control words to individual compute elements, etc. The decompressor can be coupled to a compressed control word store such as compressed control word cache 1 (CCWC1) 334. CCWC1 can include a cache such as an L1 cache that includes one or more compressed control words. CCWC1 can be coupled to a further compressed control word store such as compressed control word cache 2 (CCWC2) 336. CCWC2 can be used as an L2 cache for compressed control words. CCWC2 can be larger and slower than CCWC1. In embodiments, CCWC1 and CCWC2 can include 4-way set associativity. In embodiments, the CCWC1 cache can contain decompressed control words, in which case it could be designated as DCWC1. In that case, decompressor 332 can be coupled between CCWC1 334 (now DCWC1) and CCWC2 336.

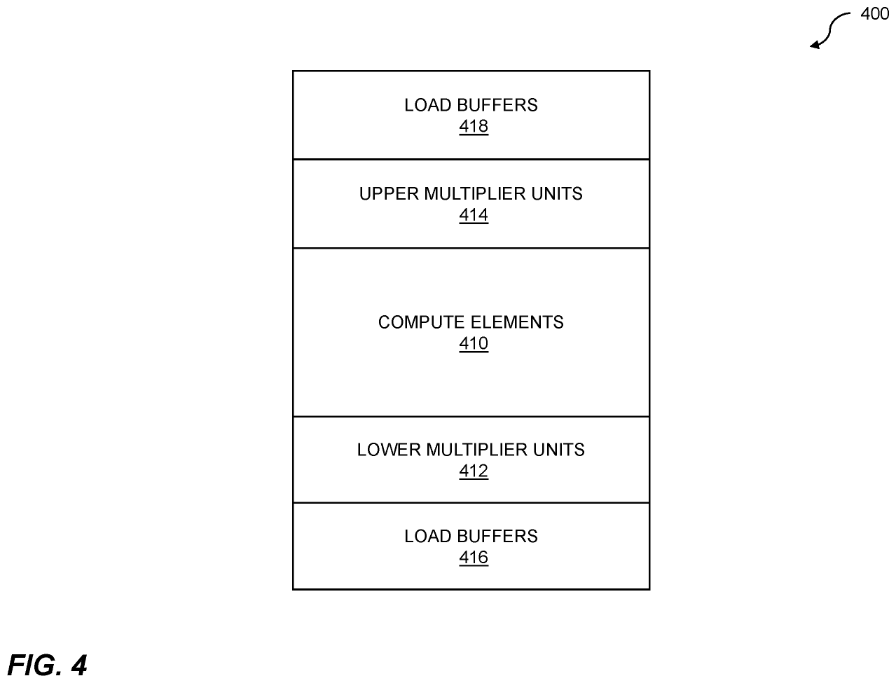

FIG. 4 shows compute element array detail 400. A compute element array can be coupled to a variety of components which enable the compute elements within the array to process one or more applications, tasks, subtasks, and so on. The components can access and provide data, perform specific high-speed operations, and the like. The compute element array and its associated components enable a parallel processing architecture with dual load buffers. The load buffers provide data for and receive data from instructions executed within the array of compute elements. The compute element array 410 can perform a variety of processing tasks, where the processing tasks can include operations such as arithmetic, vector, or matrix operations; audio and video processing operations; neural network operations; etc. The compute elements can be coupled to multiplier units such as lower multiplier units 412 and upper multiplier units 414. Multiplier units can comprise one or more multiplier elements that can perform various, programmable or fixed-function multiplications. The multiplier units can be used to perform high-speed multiplications associated with general processing tasks, multiplications associated with neural networks such as deep learning networks, multiplications associated with vector operations, and the like. The compute elements can be coupled to load queues such as load buffers 416 and load buffers 418. The load buffers, or load queues, can be coupled to the L1 data caches as discussed previously. The load queues can be used to load storage access requests from the compute elements. The load queues can track expected load latencies and can notify a control unit if a load latency exceeds a threshold. Notification of the control unit can be used to signal that a load may not arrive within an expected timeframe. The load queues can further be used to pause the array of compute elements. The load queues can send a pause request to the control unit that will pause the entire array, while individual elements can be idled under control of the control word. When an element is not explicitly controlled, it can be placed in the idle (or low power) state. No operation is performed, but ring buses can continue to operate in a “pass thru” mode to allow the rest of the array to operate properly. When a compute element is used just to route data unchanged through its ALU, it is still considered active.

While the array of compute elements is paused, background loading of the array from the memories (data and control word) can be performed. The memory systems can be free running and can continue to operate while the array is paused. Because multi-cycle latency can occur due to control signal transport, which results in additional “dead time”, it can be beneficial to allow the memory system to “reach into” the array and deliver load data to appropriate scratchpad memories while the array is paused. This mechanism can operate such that the array state is known, as far as the compiler is concerned. When array operation resumes after a pause, new load data will have arrived at a scratchpad, as required for the compiler to maintain the statically scheduled model.

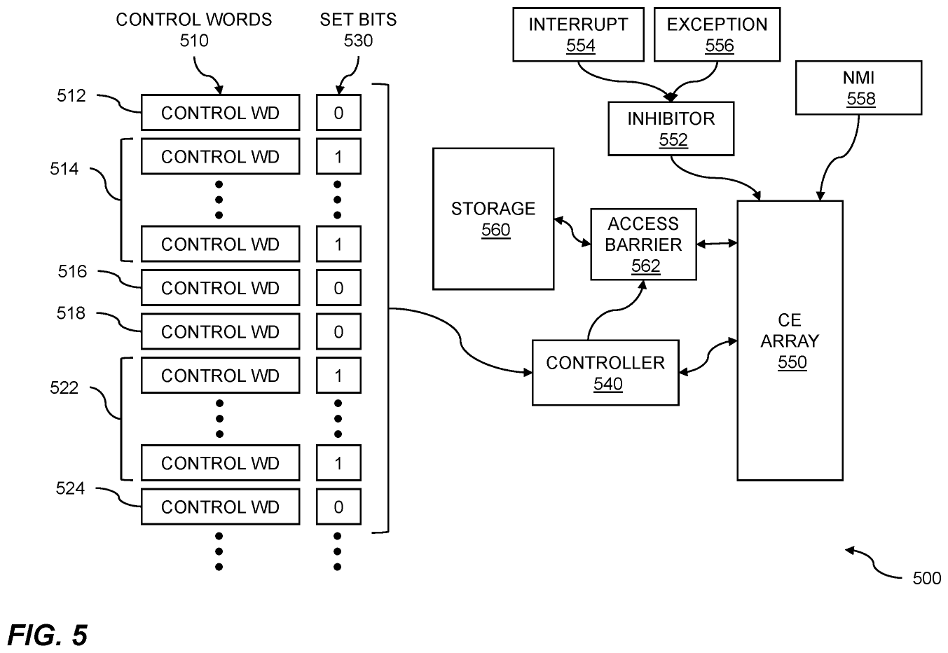

FIG. 5 is a block diagram for atomic operation. Discussed above, an atomic operation can include an operation that can be performed independently of other operations. That is, the operation can read data, modify the data, write the data, and so on, without relying on or interacting with other operations. An atomic operation can include a single operation, an operation and at least one additional operation, and so on. Execution of one or more atomic operations is enabled by a parallel processing architecture for atomic operations. The parallel processing architecture can be based on an array of compute elements. A two-dimensional (2D) array of compute elements is accessed, wherein each compute element within the array of compute elements is known to a compiler and is coupled to its neighboring compute elements within the array of compute elements. Control for the array of compute elements is provided on a cycle-by-cycle basis, wherein the control is enabled by a stream of wide control words generated by the compiler, and wherein at least one of the control words involves an operation requiring at least one additional operation. A bit of the at least one control word is set, wherein the bit indicates a multicycle operation. The at least one control word is executed, on at least one compute element within the array of compute elements, based on the bit.

The block diagram for atomic operation 500 includes control words 510. The control words can be associated with one or more processing tasks, one or more subtasks associated with the one or more tasks, and so on. The control words can be generated by a compiler. The control words can be associated with atomic operations. A given atomic operation can be based on a single control word such as atomic operations 512, 516, 518, and 524. Other atomic operations can be based on a control word and at least one additional control word, such as atomic operations 514 and 522. The block diagram 500 can include set bits 530, where set bits can be associated with each control word. The set bits can be set to zero and one. A set bit value of zero can indicate that an atomic operation can include at least a single control word, while a set bit value of one can indicate that an atomic operation can include at least a single control word and at least one additional control word. The control words and set bits can be stored in memory, caches, register files, etc.

The block diagram 500 can include a controller 540. The controller can receive control words. The controller can decompress the control words, process the control words, and so on. The block diagram 500 can include an array of compute elements 550. The compute elements can include processing elements, storage elements, communications elements, etc. The controller can use the control words to configure the array of compute elements, to access data needed by the compute elements, to preload data, and the like. The controller can provide control words for execution to one or more compute elements within the array of compute elements. The block diagram 500 can include an inhibitor 552. The operation of the inhibitor can be based on a value of a set bit. The inhibitor can be used to enable communication of one or more interrupts 554, one or more exceptions 556, and so on, to compute elements within the array of compute elements, while the compute elements are executing one or more control words. In embodiments, the bit inhibits the at least one compute element from having its operation interrupted. Since the operation being performed by the compute element can be an atomic operation, inhibiting interrupts or exceptions enables the compute element to complete its operation. In embodiments, the interrupted operation can include an attempted thread swap out. There are interrupts that can be permitted based on a priority or precedence of the interrupt.

The block diagram 500 can include a non-maskable interrupt (NMI) component 558. In embodiments, a non-maskable interrupt (NMI) can override the setting a bit. A non-maskable interrupt can be generated by software such as an operating system or application, hardware such as an arithmetic logic unit (ALU), a memory management unit (MMU), etc. In embodiments, an arithmetic exception or a memory exception can override the setting a bit. An arithmetic exception can include division by zero, an overflow, an underflow, and so on. A memory exception can include data unavailability, memory access timeout, etc. The block diagram 500 can include an access barrier 562. The access barrier can be set based on a value of a set bit. In embodiments, an atomic duration can enable a memory access barrier. The atomic duration can be controlled by a number of consecutive control words that have their multicycle operation bits set. The block diagram 500 can include storage 560. The storage can be based on registers, register files, caches within the array of compute elements, storage such as caches coupled to the array of compute elements, and so on. Access by the array of compute elements to storage can be blocked by the access barrier for an atomic duration. When the control words associated with the atomic duration have been executed, the access barrier can be disabled.

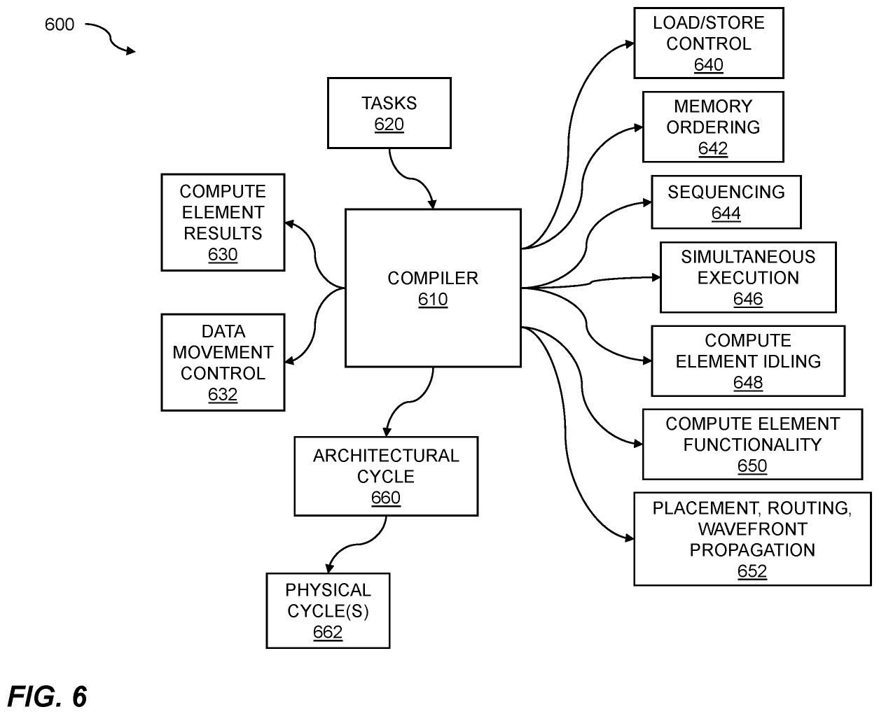

FIG. 6 shows a system block diagram for compiler interactions. Discussed throughout, compute elements within a 2D array are known to a compiler which can compile tasks and subtasks for execution on the array. The compiled tasks and subtasks are executed to accomplish task processing. A variety of interactions, such as placement of tasks, routing of data, and so on, can be associated with the compiler. The compiler interactions enable a parallel processing architecture for atomic operations. A two-dimensional (2D) array of compute elements is accessed, wherein each compute element within the array of compute elements is known to a compiler and is coupled to its neighboring compute elements within the array of compute elements. Control for the array of compute elements is provided on a cycle-by-cycle basis, wherein the control is enabled by a stream of wide control words generated by the compiler, and wherein at least one of the control words involves an operation requiring at least one additional operation. A bit of the at least one control word is set, wherein the bit indicates a multicycle operation. The at least one control word is executed, on at least one compute element within the array of compute elements, based on the bit.

The system block diagram 600 includes a compiler 610. The compiler can include a high-level compiler such as a C, C++, Python, or similar compiler. The compiler can include a compiler implemented for a hardware description language such as a VHDL™ or Verilog™ compiler. The compiler can include a compiler for a portable, language-independent, intermediate representation such as low-level virtual machine (LLVM) intermediate representation (IR). The compiler can generate a set of directions that can be provided to the computer elements and other elements within the array. The compiler can be used to compile tasks 620. The tasks can include a plurality of tasks associated with a processing task. The tasks can further include a plurality of subtasks. The tasks can be based on an application such as a video processing or audio processing application. In embodiments, the tasks can be associated with machine learning functionality. The compiler can generate directions for handling compute element results 630. The compute element results can include results derived from arithmetic, vector, array, and matrix operations; Boolean operations; and so on. In embodiments, the compute element results are generated in parallel in the array of compute elements. Parallel results can be generated by compute elements when the compute elements can share input data, use independent data, and the like. The compiler can generate a set of directions that controls data movement 632 for the array of compute elements. The control of data movement can include movement of data to, from, and among compute elements within the array of compute elements. The control of data movement can include loading and storing data, such as temporary data storage, during data movement. In other embodiments, the data movement can include intra-array data movement.

As with a general-purpose compiler used for generating tasks and subtasks for execution on one or more processors, the compiler can provide directions for task and subtasks handling, input data handling, intermediate and resultant data handling, and so on. The compiler can further generate directions for configuring the compute elements, storage elements, control units, ALUs, and so on, associated with the array. As previously discussed, the compiler generates directions for data handling to support the task handling. In the system block diagram, the data movement can include controlling loads and stores 640 with a memory array. The loads and stores can include handling various data types such as integer, real or float, double-precision, character, and other data types. The loads and stores can load and store data into local storage such as registers, register files, caches, and the like. The caches can include one or more levels of caches such as a level 1 (L1) cache, level 2 (L2) cache, level 3 (L3) cache, and so on. The loads and stores can also be associated with storage such as shared memory, distributed memory, etc. In addition to the loads and stores, the compiler can handle other memory and storage management operations including memory precedence. In the system block diagram, the memory access precedence can enable ordering of memory data 642. Memory data can be ordered based on task data requirements, subtask data requirements, and so on. The memory data ordering can enable parallel execution of tasks and subtasks.

In the system block diagram 600, the ordering of memory data can enable compute element result sequencing 644. In order for task processing to be accomplished successfully, tasks and subtasks must be executed in an order that can accommodate task priority, task precedence, a schedule of operations, and so on. The memory data can be ordered such that the data required by the tasks and subtasks can be available for processing when the tasks and subtasks are scheduled to be executed. The results of the processing of the data by the tasks and subtasks can therefore be ordered to optimize task execution, to reduce or eliminate memory contention conflicts, etc. The system block diagram includes enabling simultaneous execution 646 of two or more potential compiled task outcomes based on the set of directions. The code that is compiled by the compiler can include branch points, where the branch points can include computations or flow control. Flow control transfers control word execution to a different sequence of control words. Since the result of a branch decision, for example, is not known a priori, then the operational sequences associated with the two or more potential task outcomes can be, for at least the initial cycles, speculatively encoded in the same control word, and the actions performed for the control path not taken can be ignored, erased, reverted, etc. as appropriate. In embodiments, the two or more potential compiled outcomes can be executed on spatially separate compute elements within the array of compute elements.

The system block diagram includes compute element idling 648. In embodiments, the set of directions from the compiler can idle an unneeded compute element within a row of compute elements located in the array of compute elements. Not all of the compute elements may be needed for processing, depending on the tasks, subtasks, and so on that are being processed. The compute elements may not be needed simply because there are fewer tasks to execute than there are compute elements available within the array. In embodiments, the idling can be controlled by a single bit in the control word generated by the compiler. In the system block diagram, compute elements within the array can be configured for various compute element functionalities 650. The compute element functionality can enable various types of compute architectures, processing configurations, and the like. In embodiments, the set of directions can enable machine learning functionality. The machine learning functionality can be trained to process various types of data such as image data, audio data, medical data, etc. In embodiments, the machine learning functionality can include neural network implementation. The neural network can include a convolutional neural network, a recurrent neural network, a deep learning network, and the like. The system block diagram can include compute element placement, results routing, and computation wavefront propagation 652 within the array of compute elements. The compiler can generate directions or control that can place tasks and subtasks on compute elements within the array. The placement can include placing tasks and subtasks based on data dependencies between or among the tasks or subtasks, placing tasks that avoid memory conflicts or communications conflicts, etc. The directions can also enable computation wavefront propagation. Computation wavefront propagation can describe and control how execution of tasks and subtasks proceeds through the array of compute elements.

In the system block diagram, the compiler can control architectural cycles 660. An architectural cycle can include an abstract cycle that is associated with the elements within the array of elements. The elements of the array can include compute elements, storage elements, control elements, ALUs, and so on. An architectural cycle can include an “abstract” cycle, where an abstract cycle can refer to a variety of architecture level operations such as a load cycle, an execute cycle, a write cycle, and so on. The architectural cycles can refer to macro-operations of the architecture rather than to low level operations. One or more architectural cycles are controlled by the compiler. Execution of an architectural cycle can be dependent on two or more conditions. In embodiments, an architectural cycle can occur when a control word is available to be pipelined into the array of compute elements and when all data dependencies are met That is, the array of compute elements does not have to wait for either dependent data to load or for a full memory queue to clear. In the system block diagram, the architectural cycle can include one or more physical cycles 662. A physical cycle can refer to one or more cycles at the element level required to implement a load, an execute, a write, and so on. In embodiments, the set of directions can control the array of compute elements on a physical cycle-by-cycle basis. The physical cycles can be based on a clock such as a local, module, or system clock, or some other timing or synchronizing technique. In embodiments, the physical cycle-by-cycle basis can include an architectural cycle. The physical cycles can be based on an enable signal for each element of the array of elements, while the architectural cycle can be based on a global, architectural signal. In embodiments, the compiler can provide, via the control word, valid bits for each column of the array of compute elements, on the cycle-by-cycle basis. A valid bit can indicate that data is valid and ready for processing, that an address such as a jump address is valid, and the like. In embodiments, the valid bits can indicate that a valid memory load access is emerging from the array. The valid memory load access from the array can be used to access data within a memory or storage element. In other embodiments, the compiler can provide, via the control word, operand size information for each column of the array of compute elements. The operand size is used to determine how many load operations may be required to obtain data. Various operand sizes can be used. In embodiments, the operand size can include bytes, half-words, words, and double-words.

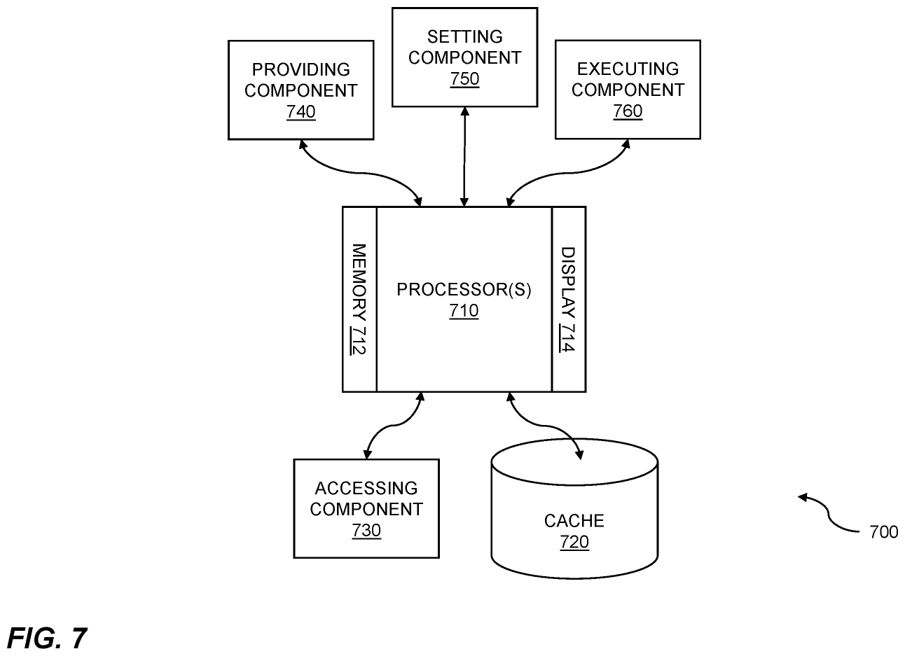

FIG. 7 is a system diagram for parallel processing. The parallel processing is performed in a parallel processing architecture that can include a two-dimensional array of compute elements. The parallel processing architecture enables atomic operations. The system 700 can include one or more processors 710, which are attached to a memory 712 which stores instructions. The system 700 can further include a display 714 coupled to the one or more processors 710 for displaying data; intermediate steps; directions; control words; compressed control words; control words implementing Very Long Instruction Word (VLIW) functionality; topologies including systolic, vector, cyclic, spatial, streaming, or VLIW topologies; and so on. In embodiments, one or more processors 710 are coupled to the memory 712, wherein the one or more processors, when executing the instructions which are stored, are configured to: access a two-dimensional (2D) array of compute elements, wherein each compute element within the array of compute elements is known to a compiler and is coupled to its neighboring compute elements within the array of compute elements; provide control for the array of compute elements on a cycle-by-cycle basis, wherein the control is enabled by a stream of wide control words generated by the compiler, and wherein at least one of the control words involves an operation requiring at least one additional operation; set a bit of the at least one control word, wherein the bit indicates a multicycle operation; and execute the at least one control word, on at least one compute element within the array of compute elements, based on the bit. In embodiments, the multicycle operation comprises a read-modify-write (RMW) operation. The read and write operations can include reading and writing to local storage, cache storage, remote storage such as system memory, and so on. The modify operation can include an arithmetic operation, a logical operation, etc. In other embodiments, the bit that is set inhibits the at least one compute element from having its operation interrupted, thus enabling the at least one compute element to perform an atomic multicycle operation. The interrupted operation can include an attempted thread swap out. Operations can be performed on data that can be promoted, where the promoted data can be used for a downstream operation. The downstream operation can include an arithmetic or Boolean operation, a matrix operation, and so on. The compute elements can include compute elements within one or more integrated circuits or chips, compute elements or cores configured within one or more programmable chips such as application specific integrated circuits (ASICs), field programmable gate arrays (FPGAs), heterogeneous processors configured as a mesh, standalone processors, etc.

The system 700 can include a cache 720. The cache 720 can be used to store data such as data associated with the multicycle operations, directions to compute elements, control words, intermediate results, microcode, and so on. The cache can comprise a small, local, easily accessible memory available to one or more compute elements. In embodiments, the data that is stored can include data associated with the atomic operations. Embodiments include storing relevant portions of one or more control words within the cache associated with the array of compute elements. The cache can be accessible to one or more compute elements. The cache if present, can include a dual read, single write (2R1 W) cache. That is, the 2R1 W cache can enable two read operations and one write operation contemporaneously without the read and write operations interfering with one another. The system 700 can include an accessing component 730. The accessing component 730 can include control logic and functions for accessing a two-dimensional (2D) array of compute elements, wherein each compute element within the array of compute elements is known to a compiler and is coupled to its neighboring compute elements within the array of compute elements. A compute element can include one or more processors, processor cores, processor macros, and so on. Each compute element can include an amount of local storage. The local storage may be accessible to one or more compute elements. Each compute element can communicate with neighbors, where the neighbors can include nearest neighbors or more remote “neighbors”. Communication between and among compute elements can be accomplished using a bus such as an industry standard bus, a ring bus, a network such as a wired or wireless computer network, etc. In embodiments, the ring bus is implemented as a distributed multiplexor (MUX). Discussed below, operations associated with an indicated branch decision can be executed, while operations associated with a branch decision that is not indicated can be suppressed.

The system 700 can include a providing component 740. The providing component 740 can include control and functions for providing control for the array of compute elements on a cycle-by-cycle basis, wherein the control is enabled by a stream of wide control words generated by the compiler, and wherein at least one of the control words involves an operation requiring at least one additional operation. The control words can be based on low-level control words such as assembly language words, microcode words, and so on. The control of the array of compute elements on a cycle-by-cycle basis can include configuring the array to perform various compute operations. In embodiments, the stream of wide control words generated by the compiler provides direct, fine-grained control of the 2D array of compute elements. The compute operations can enable audio or video processing, artificial intelligence processing, machine learning, deep learning, and the like. The providing control can be based on microcode control words, where the microcode control words can include ALU opcode fields, data fields, compute array configuration fields, etc. The compiler that generates the control can include a general-purpose compiler, a parallelizing compiler, a compiler optimized for the array of compute elements, a compiler specialized to perform one or more processing tasks, and so on. The providing control can implement one or more topologies such as processing topologies within the array of compute elements. In embodiments, the topologies implemented within the array of compute elements can include a systolic, a vector, a cyclic, a spatial, a streaming, or a Very Long Instruction Word (VLIW) topology. Other topologies can include a neural network topology. A control word can enable machine learning functionality for the neural network topology.

A multicycle operation can be part of a compiled task, which can be one of many tasks associated with a task processing job. The compiled task can be executed on one or more compute elements within the array of compute elements. In embodiments, the executing of the compiled task can be distributed across compute elements in order to parallelize the execution. The executing the compiled task can include executing the tasks for processing multiple datasets. Embodiments can include providing simultaneous execution of two or more potential compiled task outcomes. Recall that the provided control word or words can control code conditionality for the array of compute elements. In embodiments, the two or more potential compiled task outcomes comprise a computation result or a flow control. The code conditionality, which can be based on computing a condition such as a value, a Boolean equation, and so on, can cause execution of one of two or more sequences of operations, based on the condition. In embodiments, the two or more potential compiled outcomes can be controlled by a same control word. In other embodiments, the conditionality can determine code jumps. The two or more potential compiled task outcomes can be based on one or more branch paths, data, etc. The executing can be based on one or more directions or control words. The executing tasks can be performed by compute elements located throughout the array of compute elements.

The system 700 can include a setting component 750. The setting component 750 can include control logic and functions for setting a (lock) bit of the at least one control word, wherein the bit indicates a multicycle operation. Discussed above and throughout, a multicycle operation can be based on an atomic operation. Recall that atomic operations are operations that require non-interruptible processing for successful completion. In a sense, they need to be executed independently from other operations. The operations can include multicycle operations. By setting a bit associated with a control word, and setting bits associated with a subsequent control word that comprises the multicycle operation, the multicycle operation can be generated by the compiler. Further recall that operations can include accessing data, processing data, storing data, routing data, and the like. By enabling lock bits across temporally sequential multicycle operations, basic atomic operations can be strung together by the compiler to accomplish more powerful or otherwise useful atomic operations. In embodiments, the multicycle operation can include a read-modify-write (RMW) operation. The “modify” operation can include arithmetic, logic, array, matrix, tensor, and other operations. In embodiments, the bit can inhibit the at least one compute element from having its operation interrupted. A multicycle operation can thus proceed without risk of being halted, suspended, swapped out, etc. In embodiments, the interrupted operation can include an attempted thread swap out.

The system 700 can include an executing component 760. The executing component 760 can include control logic and functions for executing the at least one control word, on at least one compute element within the array of compute elements, based on the bit. Mentioned previously, the bit can inhibit interruption of the executing of one or more control words. There are conditions, however, which can cause the executing to be interrupted anyway. In embodiments, a non-maskable interrupt (NMI) can override the setting a bit. A non-maskable interrupt can include an exception which can prevent the executing from being performed, from completing properly, etc. In embodiments, an arithmetic exception or a memory exception can override the setting of a lock bit. An arithmetic exception can include an overflow, an underflow, division by zero, and the like. A memory exception can include data not available, an access timeout, etc. Discussed throughout, the execution of a control word, a code, a program, etc., can be associated with operational cycles of the 2D array of compute elements. In embodiments, two or more operational cycles of the cycle-by-cycle basis can be coalesced. The coalescing can be used to control a number of operational cycles. In embodiments, the coalescing can enable a reduction of operational cycles of the cycle-by-cycle basis. The reduction of operational cycles can be accomplished by performing two or more operations in a given cycle, combining read or write operations within a cycle, etc.

The system 700 can include a computer program product embodied in a non-transitory computer readable medium for task processing, the computer program product comprising code which causes one or more processors to perform operations of: accessing a two-dimensional (2D) array of compute elements, wherein each compute element within the array of compute elements is known to a compiler and is coupled to its neighboring compute elements within the array of compute elements; providing control for the array of compute elements on a cycle-by-cycle basis, wherein the control is enabled by a stream of wide control words generated by the compiler, and wherein at least one of the control words involves an operation requiring at least one additional operation; setting a bit of the at least one control word, wherein the bit indicates a multicycle operation; and executing the at least one control word, on at least one compute element within the array of compute elements, based on the bit.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for task processing comprising:
accessing a two-dimensional (2D) array of compute elements, wherein each compute element within the array of compute elements is known to a compiler and is coupled to its neighboring compute elements within the array of compute elements;
providing control for the array of compute elements on a cycle-by-cycle basis, wherein the control is enabled by a stream of wide control words generated by the compiler, and wherein at least one of the control words involves an operation requiring at least one additional operation;
setting a bit of the at least one control word, wherein the bit indicates a multicycle operation; and
executing the at least one control word, on at least one compute element within the array of compute elements, based on the bit.

2. The method of claim 1 wherein the multicycle operation comprises a read-modify-write (RMW) operation.

3. The method of claim 1 wherein the bit inhibits the at least one compute element from having its operation interrupted.

4. The method of claim 3 wherein the interrupted operation comprises an attempted thread swap out.

5. The method of claim 1 further comprising setting one or more additional bits on one or more control words immediately following the at least one control word.

6. The method of claim 5 wherein the one or more additional bits continue to inhibit the at least one compute element from having its operation interrupted.

7. The method of claim 5 wherein the bit and the one or more additional bits enable an atomic, multi-control word operation.

8. The method of claim 7 wherein the atomic multi-control word operation comprises a read-modify-write (RMW) operation.

9. The method of claim 5 wherein an atomic duration is controlled by a number of consecutive control words having their multicycle operation bits set.

10. The method of claim 9 wherein the atomic duration enables a memory access barrier.

11. The method of claim 1 wherein the operation requiring at least one additional operation is indicated in the at least one of the control words and a subsequent control word.

12. The method of claim 1 wherein the operation requiring at least one additional operation is indicated in the at least one of the control words.

13. The method of claim 1 wherein successful completion of the at least one additional operation comprises an atomic operation.

14. The method of claim 1 further comprising un-inhibiting the at least one compute element upon receipt of a control word without having its multi-cycle operation bit set.

15. The method of claim 1 further comprising enabling selective interrupt enablement based on the setting a bit.

16. The method of claim 15 wherein the selective interrupt enablement is further based on setting an additional bit.

17. The method of claim 1 wherein a non-maskable interrupt (NMI) overrides the setting a bit.

18. The method of claim 1 wherein an arithmetic exception or a memory exception overrides the setting a bit.

19. The method of claim 1 wherein the bit comprises a control word atomic lock bit.

20. The method of claim 1 wherein the compiler maps machine learning functionality to the array of compute elements.

21. The method of claim 20 wherein the machine learning functionality includes a neural network implementation.

22. The method of claim 1 wherein the stream of wide control words generated by the compiler provides direct, fine-grained control of the 2D array of compute elements.

23. A computer program product embodied in a non-transitory computer readable medium for task processing, the computer program product comprising code which causes one or more processors to perform operations of:
accessing a two-dimensional (2D) array of compute elements, wherein each compute element within the array of compute elements is known to a compiler and is coupled to its neighboring compute elements within the array of compute elements;
providing control for the array of compute elements on a cycle-by-cycle basis, wherein the control is enabled by a stream of wide control words generated by the compiler, and wherein at least one of the control words involves an operation requiring at least one additional operation;
setting a bit of the at least one control word, wherein the bit indicates a multicycle operation; and
executing the at least one control word, on at least one compute element within the array of compute elements, based on the bit.

24. A computer system for task processing comprising:
a memory which stores instructions;
one or more processors coupled to the memory, wherein the one or more processors, when executing the instructions which are stored, are configured to:
access a two-dimensional (2D) array of compute elements, wherein each compute element within the array of compute elements is known to a compiler and is coupled to its neighboring compute elements within the array of compute elements;
provide control for the array of compute elements on a cycle-by-cycle basis, wherein the control is enabled by a stream of wide control words generated by the compiler, and wherein at least one of the control words involves an operation requiring at least one additional operation;
set a bit of the at least one control word, wherein the bit indicates a multicycle operation; and
execute the at least one control word, on at least one compute element within the array of compute elements, based on the bit.
